(19) United States
(12) Patent Application Publication
(10) Pub. No.: US 2025/0299527 A1
(43) Pub. Date: Sep. 25, 2025

(54) GAMING TABLE TOKEN SENSING APPARATUS AND RELATED SYSTEMS AND METHODS

(71) Applicant: LNW Gaming, Inc., Las Vegas, NV (US)

(72) Inventors: Scott HILBERT, Sparks, NV (US); Joseph R. HEDRICK, Reno, NV (US); Frank A. SCARPA, JR., Henderson, NV (US); Matt MOSES, Las Vegas, NV (US); Collin Patrick MOORE, Henderson, NV (US); Miguel A. VEGA, Chicago, IL (US); Dhaval SHAH, Itasca, IL (US); Matthew J. LUCCHETTI, Las Vegas, NV (US); Kristofer PIZER, Hickory, PA (US); Daniel AMBROSE, Las Vegas, NV (US); Matthew BOOTH, Henderson, NV (US)

(21) Appl. No.: 19/088,412

(22) Filed: Mar. 24, 2025

Related U.S. Application Data
(60) Provisional application No. 63/569,384, filed on Mar. 25, 2024.

(51) Int. Cl. G07F 17/32

(52) U.S. Cl. CPC G07F 17/3206; G07F 17/322

(57) ABSTRACT

A token sensor for a gaming table and a related system and method are provided. In a typical configuration, multiple token sensors are positioned at respective locations of a game layout installed above a cushioning layer of the gaming table that covers a support surface (top) of the gaming table. In accordance with some embodiments, each token sensor includes an electronic display for the display of a randomly selected potential award. Each potential award may be won when a token has been detected by its associated sensor and a qualifying hand occurs at its respective location. In some embodiments, a qualifying hand is not required for the displayed award to be won. The potential awards may include, but are not limited to, progressive awards and award modifiers such as multipliers.

### CROSS-REFERENCE TO RELATED APPLICATION(S)

This patent application claims priority benefit of U.S. Provisional Patent Application No. 63/569,384 filed Mar. 25, 2024, the contents of which is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023-2025, LNW Gaming, Inc.

### FIELD OF THE INVENTION

The present invention relates to the field of table gaming, wagering methods and apparatus on gaming tables, and automated recognition of wagers on gaming tables.

### BACKGROUND OF THE INVENTION

In casino table games, wagering was originally done (and in many circumstances is still done) exclusively by the physical placement of money, currency, coins, tokens or chips on the gaming table and allowing the wager to remain on the gaming table until conclusion of the game and resolution of the wager(s). The placement of physical wagers on tables allows for some players to attempt to commit fraud on casinos by late placement of wagers, alteration of wagers and particularly placement of side bet wagers, bonus wagers and jackpot wagers.

Side bets, bonus and jackpot payouts can reach levels of hundreds of thousands of dollars at gaming tables and the temptation to commit fraud at a table increases. Similarly, the casinos need to prevent fraud increases to assure the game is fair to players. With the linkage of games (e.g., different games) within a casino or among different casinos, a uniform standard of control is needed that assures equal avoidance and prevention of cheating at all tables and at all facilities.

In the past twenty years, numerous systems have been provided or disclosed for the automated recognition of wagers, including side bet, bonus and jackpot wagers. Among the disclosures of these types of technologies include U.S. Pat. No. 5,794,964 (Jones) in which a sensor detects when a gaming token is dropped into a slot on the gaming table and a coin acceptor is mounted to detect the passage of a gaming token through the slot.

U.S. Pat. Nos. 5,544,892, 6,299,534 and 7,367,884 (Breeding) discloses an apparatus for detecting the presence of a gaming token. This apparatus has at least one predetermined location for receiving a gaming token on a gaming table. At each predetermined location for receiving a gaming token designated on the gaming table, a proximity sensor is mounted to the gaming table such that each sensor is aligned with one predetermined location. A decoder is electrically connected to each proximity sensor for determining whether a gaming token is present at each predetermined location. When the presence of a gaming token is sensed by the decoder, the player's bet is registered by transmission of the sensed presence to a processor. Each sensor in these systems has a connection to a processor (e.g., game processor or system processor) where the individual wagers are recorded and identified. In a preferred embodiment, there is a backlight under the predetermined location that lights up when a wager is made at that location that remains lit when the processor identifies acceptance and recognition of the wager during each game or round of play at the gaming table.

### SUMMARY OF THE INVENTION

A token sensor for a gaming table and a related system and method are provided. In a typical configuration, multiple token sensors are positioned at respective locations of a game layout installed above a cushioning layer of the gaming table that covers a support surface (top) of the gaming table. In accordance with some embodiments, each token sensor includes an electronic display for the display of a randomly selected potential award. Each potential award may be won when a token has been detected by its associated sensor and a qualifying hand occurs at its respective location. In some embodiments, a qualifying hand is not required for the displayed award to be won. The potential awards may include, but are not limited to, progressive awards and award modifiers such as multipliers.

A plurality of gaming tables may be connected together as a system. This system may be used to link progressive proprietary table games such as the CARIBBEAN STUD® poker game, the THREE CARD POKER PROGRESSIVE® poker game, the PROGRESSIVE TEXAS HOLD 'EM™ poker game and a similar variety of blackjack, pai gow poker and baccarat games. Examples of systems which link multiple table games with token sensors are disclosed in U.S. Pat. Nos. 5,393,067 and 4,861,041. The present system can include multiple gaming tables each with a dealer terminal connected to a server such as the commercially available a GM Atlas system sold by Light and Wonder, Inc.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a top plan view of an exemplary gaming table apparatus with an integrated wager sensing system including a plurality of token bet sensors.

FIG. 2A is a top perspective view of an exemplary token sensor assembly in accordance with one or more embodiments.

FIG. 2B is a side isometric view of the exemplary token sensor assembly with a token in place on the assembly in accordance with one or more embodiments.

FIG. 2C is a top view of the exemplary token sensor assembly illustrating touch zones in accordance with one or more embodiments.

FIG. 3A is a side cross-sectional view of the exemplary token sensor assembly mounted to a gaming table in accordance with one or more embodiments.

FIG. 3B is a side cross-sectional view of a lower bracket of the exemplary token sensor assembly in accordance with one or more embodiments.

FIG. 3C is a top perspective view of a mount for securing the exemplary token sensor to the gaming table in accordance with one or more embodiments.

FIG. 4A is an exploded cross-sectional view of a puck assembly of the exemplary token sensor in accordance with one or more embodiments.

FIG. 4B is a bottom perspective view of a MCU printed circuit board of the puck assembly of FIG. 4A in accordance with one or more embodiments.

FIG. 4C is a bottom perspective view of a bezel of the puck assembly of FIG. 4A in accordance with one or more embodiments.

FIG. 4D is a bottom perspective view of a puck base of the puck assembly of FIG. 4A in accordance with one or more embodiments.

FIG. 4E is an upper perspective view of a ring printed circuit board of the puck assembly of FIG. 4A.

FIG. 4F is top view of the bezel of FIG. 4C illustrating the transmission of light through the bezel in accordance with one or more embodiments.

FIG. 4G is a side cross-sectional view of the bezel of FIGS. 4C and 4F in accordance with one or more embodiments.

FIG. 5 is a block diagram of the exemplary token sensor controller illustrating the connections between major components in accordance with one or more embodiments.

FIG. 6 is a block diagram of a gaming table illustrating the connections between major components in accordance with one or more embodiments.

FIGS. 7A and 7B are a process flow chart for a first exemplary use case method using the components of FIG. 6 in accordance with one or more embodiments.

FIGS. 8A and 8B are a process flow chart for a second exemplary use case method using the components of FIG. 6 in accordance with one or more embodiments.

FIGS. 9A and 9B are a process flow chart for a variation of Blackjack suitable for use with the gaming table apparatus described herein in accordance with one or more embodiments.

FIGS. 10-15 illustrate the cards dealt in a series of example rounds of the Blackjack game of FIGS. 9A and 9B in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and herein described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.” The terms “light radiation” and “light” mean “light radiation.”

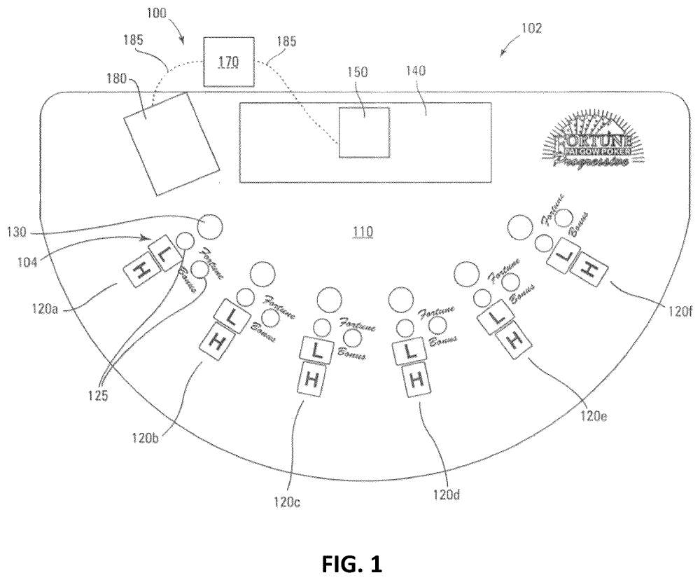

Reference to the figures will further assist in an appreciation of the present technology. FIG. 1 is an exemplary gaming table 102 with a wager sensing system 100. Preferably the wager sensing system 100 senses progressive jackpot wagers. Other examples of the invention sense primary bets, other types of side bets and combinations thereof. The wager sensing system 100 may be used for a progressive jackpot system such as the system disclosed in U.S. Pat. No. 5,794,964 (Jones) or in any other bonus or side bet feature system. According to the invention, the gaming table 102 has a gaming table layout 110, preferably a felt surface with indicia thereon identifying elements 104 of the game, such as wager positions and odds. A chip tray 140 is disposed opposite a plurality of player positions 120 (120a-120f). Preferably, chip tray 140 includes an integrated dealer input and display 150 which is part of the dealer terminal. The system further includes game controller 170 electrically connected to the integrated dealer input and display 150 by system wiring 185. Preferably, the system also includes card handling device 180, such as a shoe or a shuffler, which is also electrically connected to game controller 170 by system wiring 185. It is further preferred that the shoe or shuffler contain card reading functionality so that cards stored, delivered or withheld have at least one of suit and rank read and that information processed as desired, as disclosed for example in U.S. Pat. Nos. 7,769,232; 7,766,332; 7,764,836; 7,717,427; 7,677,565; 7,593,544; and 7,407,438.

Each player position 120 includes wagers areas 125 and a bonus bet area, which comprises a token sensor assembly 130. The preferred embodiment will allow one token sensor assembly for each player position 120, which player positions will number six or seven on a standard gaming table for games like TEXAS HOLD 'EM BONUS® poker, THREE CARD POKER® and Pai Gow Poker. Systems with parallel connections between token sensors 130 and processors are preferred over serial daisy-chained connections because failure of a single token sensor 130 will not prevent use of the remaining token sensors 130 in operation. While, in this example, each token sensor 130 is used for sensing only a bonus game or progressive wager, it is understood that token sensors could be used for any and all wager areas without deviating from the scope of the invention.

Since all player positions 120 are essentially the same, only position 120a, and in particular, the token sensor 130 at position 120a, will be described in detail. The game controller 170 provides instructions to the token sensor 130, such as instructions to begin a new round of game play or data to display on a display incorporated into each token sensor. Upon receiving these instructions, the token sensor 130 presents any display information and/or determines a presence of any particular wager, especially a progressive wager, a side bet wager, optional or mandatory bonus wager and the like.

The token sensors in prior art reference U.S. Pat. No. 7,367,884, used a modulated light sensor mounted into a machined enclosure or flanged “can,” which, in turn, is flush-mounted into the gaming table surface. The sensor detects a token, or chip, placed on top of a tens above the sensor. Thus, historically, token sensors 130 have used “vertical” sensing, where a beam of energy “light” is emitted upward and if a token is placed on the sensor, the reflected light back to a detector within the token sensor registers the token's presence. These token sensors have limitations in detection as they require calibration for the token set based on the color and material makeup of the token. When the light source in those sensors hits a “black spot” on the token (a high optical density dark spot, such as black marking), the token presence may not be sensed. A misread could also result from light reflecting off the inside of the sensor cover, or in some cases even ambient light “bleeding through” the cover to the receiver. Another limitation is that the detector must be centrally located in the token sensor 130. This limitation does not allow the center of the token sensor to be used for any other purpose, such as lighting or display of information. In contrast, in the embodiments disclosed herein, a “planar” token detection scheme that can be used over a display or otherwise fully illuminated surface is now described.

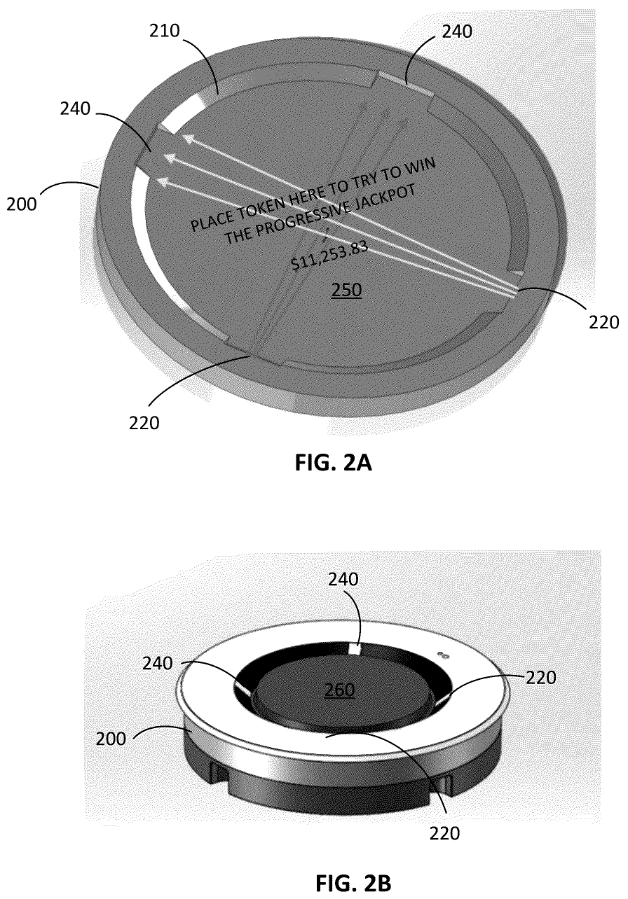

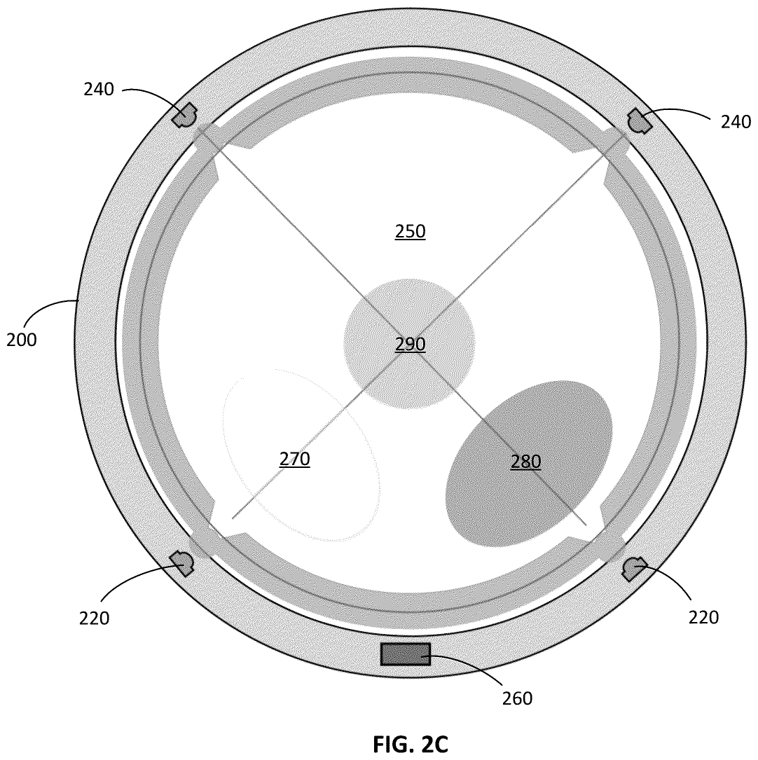

FIG. 2A broadly illustrate this planar token detection concept when no token rests atop the token sensor 200, which is akin to the token sensor 130 of FIG. 1. A plurality of light emitters 220 project light horizontally through a bezel 210 above the top surface 250 of the token sensor 200, which is akin to token sensor 130 of FIG. 1. A plurality of light detectors 240 are diametrically paired with each of the plurality of light emitters 210. When the light detectors 240 all receive light from their respective emitters 220, it is assumed that no object, such as a token, rests on the upper surface 250 of the token sensor 200 to interrupt the transmitted light.

Advantageously over the prior art, the upper surface 250 of the token sensor 200 includes an electronic display device, which may be used to present dynamic text and graphics which may include attract animations, celebratory animations, instructions or the like. These instructions, for example, may include the current amount of a progressive jackpot, as shown, or to announce “No More Bets” once wagering is no longer available at the start of a game round. The electronic display device may include a touchscreen. In alternate embodiments, the token sensor does not include a display. In these embodiments, fixed graphics or instructions may be screen printed or otherwise displayed on an opaque plate of the same dimensions as the illustrated electronic display.

FIG. 2B broadly illustrates when a token 260, such as a coin or casino chip, rests atop and covers substantially all of the upper surface 250 of the token sensor 200, blocking the beams of light from the emitters 220 from being received by their paired detectors 240.

FIG. 2C illustrates that, when no token is present, the upper surface 250 of the token sensor 200 may be used as a player input device when the game controller 170 is not expecting a token 260 on the upper surface 250 of the token sensor 200. Instead, the game controller 170 may interpret the blockage of light signals as input signals to the game controller from the dealer or, more particularly, from a player. The game controller 170 may display instructions and identify touch zones or images of buttons on the display electronic display device. Depending on which beams of light from the emitters 220 are blocked from being received by the sensors, individual touch zones 270, 280, 290 are created. A player's fingertip, for example, pressed against the middle of the upper surface 250, for example, would block both beams of light, signifying a touch in the middle touch zone 290. In more complex scenarios, the game controller 170 may instruct the player to “swipe” across the top surface, the swipe being detected as successive touches in each of the zones 270, 280, 290.

FIG. 2C also illustrates that the token sensor 200 may include an upward facing gesture sensor 260. Unlike the above-mentioned touchscreen and touch zones 270, 280, 290, which require physical contact with the token sensor 200, the token sensor 200 may also provide input information to the game controller 170 if an object, such as a player's hand, simply passes above the gesture sensor 260. For example, the game controller 170 may display instructions on the electronic display device such as, “Wave your hand over this message to spin a bonus wheel!” The game controller 170, via control logic circuitry in the token sensor 200, would then monitor the gesture sensor for an initial negative input, a positive input as the player's hand passes over the gesture sensor 260 and a final negative input that indicates that the player's hand is no longer over the token sensor 200. An exemplar case study of a game employing the display, token detection and player input capabilities of various embodiments will be presented below.

The various components of the token sensor 200 will now be described in greater detail with reference to additional figures.

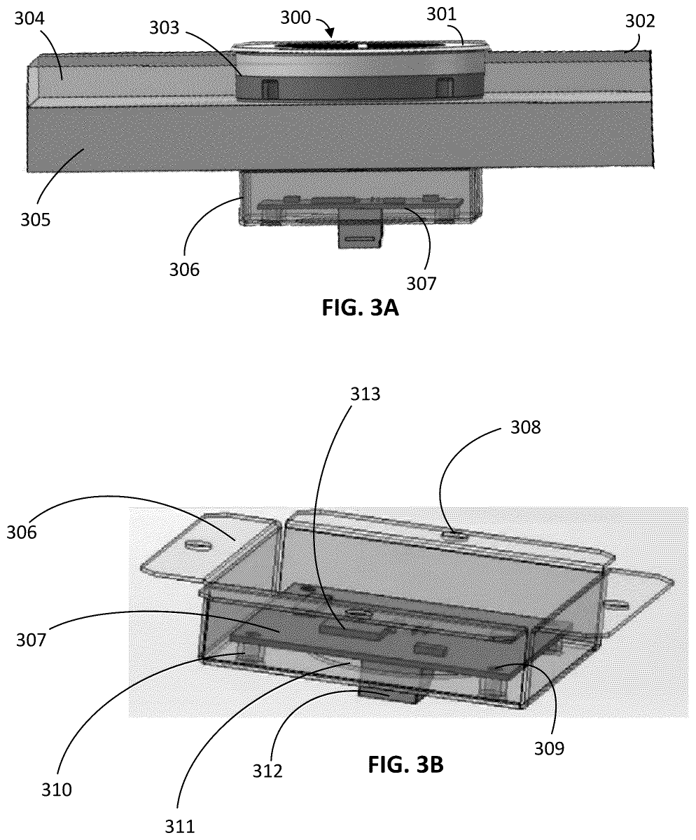

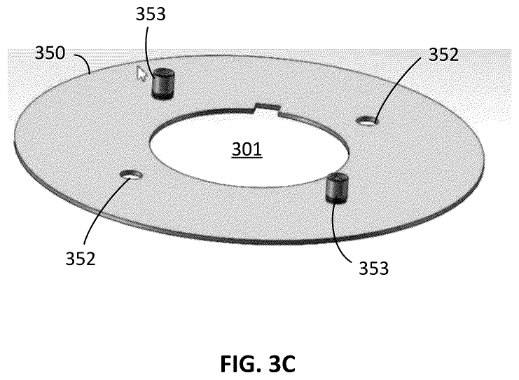

Referring FIG. 3A, a single token sensor 300 (akin to token sensors 130 and 200, above) includes a number of sub-assemblies. The token sensor 300 includes an upper “puck” assembly 303 with an upper surface 301 for receiving a token. The upper surface 301 may be a screen of an electronic display device. The upper surface 301 lies flush with or slightly (1-2 mm) above the top surface of the gaming table's game layout 302. The puck assembly 303 extends through holes in the game layout 302 and a cushioning layer 304 down to a mount (not shown here but described further below with reference to FIG. 3C) attached to the top of the support surface 305. The mount includes a center hole aligned with a hole in the support surface 305 which allows wiring connections to be made to one or more additional modules attached to the bottom of, or otherwise positioned beneath, the bottom of the support surface 305. As illustrated, these additional module(s) may contain support circuitry such as a control printed circuit board (“control PCB”) 307 contained in a lower bracket 306 attached to the lower surface of the support surface 305.

Referring to FIG. 3B, lower bracket 306 may be fastened to the lower surface of the support structure 305 by way of screws through holes 308. Control PCB 307 may be mounted inside lower bracket 306 by way of screws inserted through holes 309 in the control PCB 307 and screwed into bosses 310 of the bottom bracket 306. A hole 311 in the bottom of lower bracket 306 allows a communications connector 312, for example, a CAT5 ethernet connector, to extend below the bottom of the lower bracket 306 for the purposes of communicatively coupling the token sensor assembly 300 to the game controller 170 of FIG. 1.

Referring now to FIG. 3C, the mount 350 is fashioned from sheet metal, but may be of any suitable material. The mount 350 may be attached to the upper surface of the gaming table support surface 305 by any means such as adhesive or via fasteners. For example, the mount 350 may be attached to the support surface 305 using wood screws thorough mounting holes 352. The mount may also include threaded standoffs 353 for receiving screws for the purpose of alignment and fastening of the puck assembly 303 to the mount 350, as will be described later.

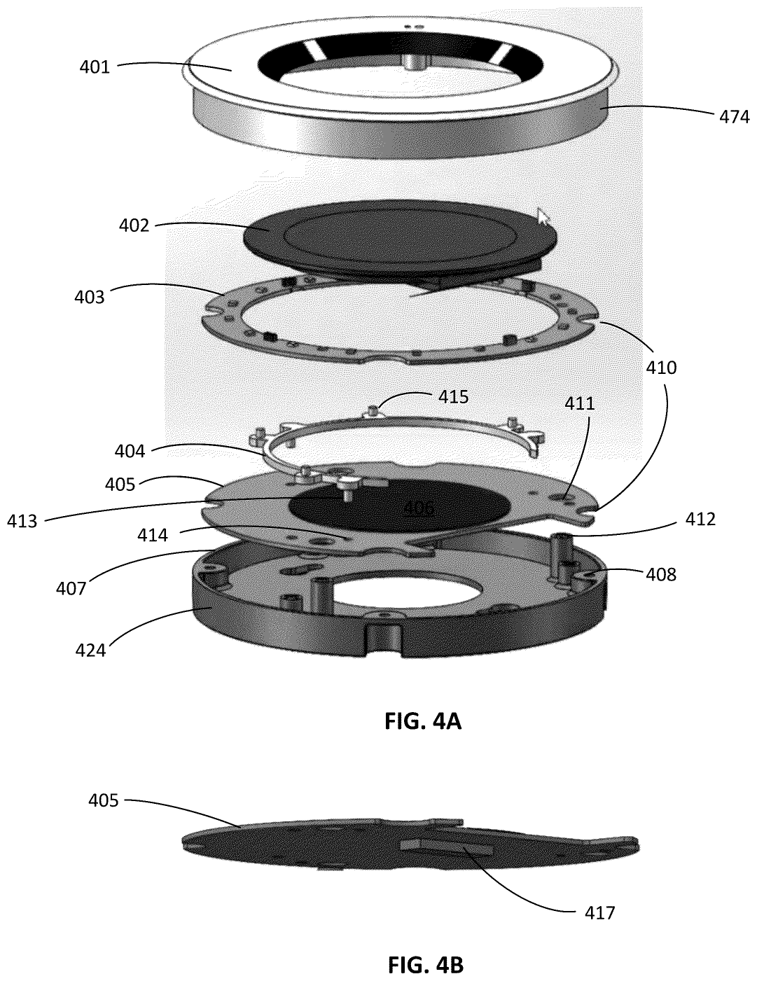

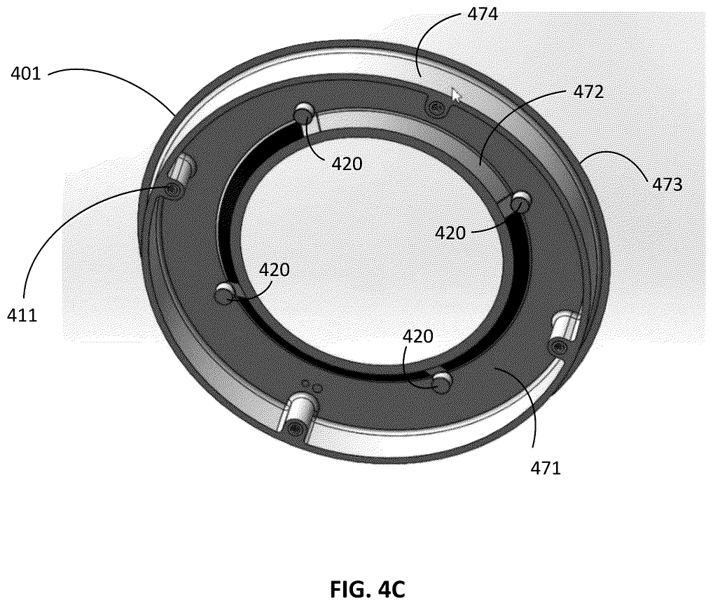

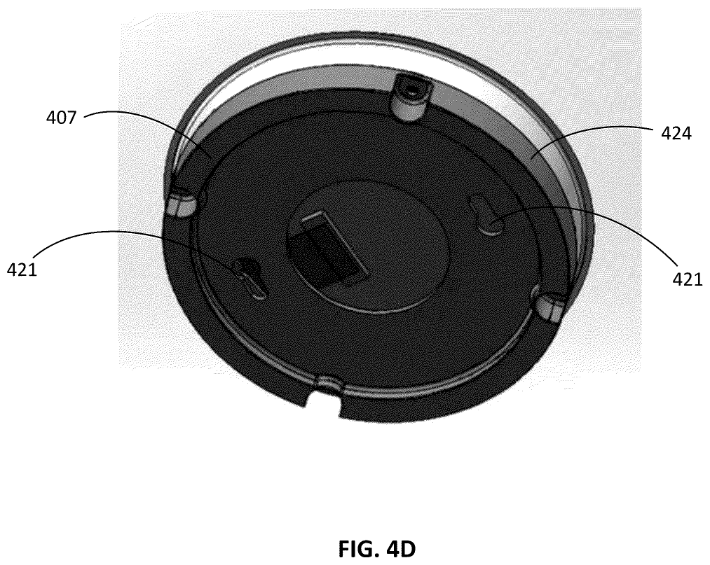

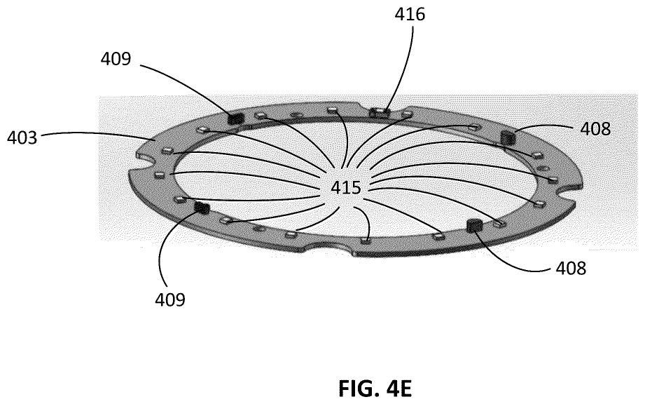

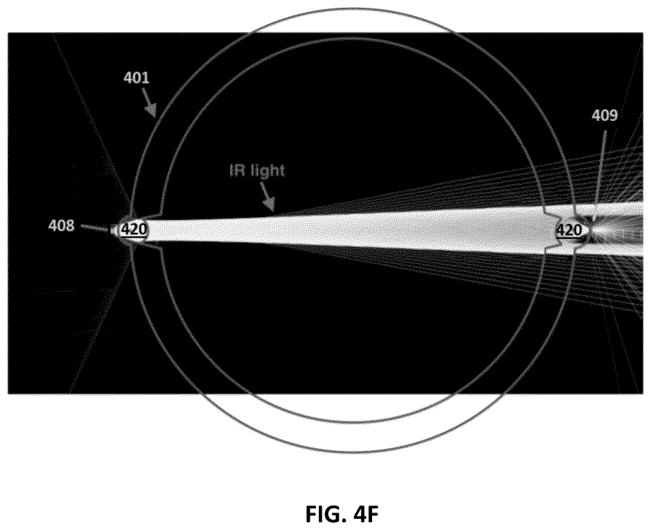

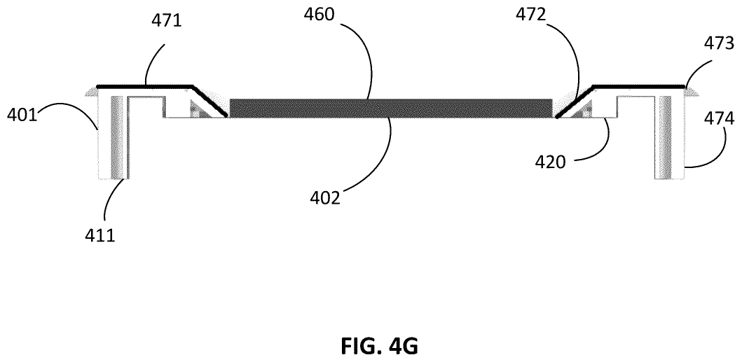

FIGS. 4A-4E provide views of various components of the puck assembly 200:

Bezel 401 is typically a single injection molded piece that protects the components of the puck 203 from spillage and other contaminants from above the gaming table surface and shields the internal components of the puck 300 from view while allowing light to pass for token sensing purposes and bezel illumination purposes. Details of the bezel 401 will be discussed further below.

Display 402 is typically a round TFT color LCD display, one example of which is a TXW210006B0-CTP, a 2.1-inch diameter 480-pixel×480-pixel display manufactured/sold by Shenzhen Tianxianwei Technology Co., LTD. While the exemplar display is round, in accordance with other embodiments, rectangular displays mounted in a round frame may be used. In accordance with some embodiments, display 402 may include a touchscreen for the acceptance of game inputs by a user.

Ring PCB 403 includes a plurality of paired light radiation (e.g., visible light, IR radiation, and/or UV radiation) emitters and light radiation detectors. These emitters and detectors are analogous to the emitters 220 and detectors 240 described above with reference to FIG. 2. The ring PCB 403 further includes a number of upward facing red-green-blue (RGB) light emitting diodes (LEDs) which are visible through the upper surface of the bezel assembly 401. The emitters, detectors and LEDs will be discussed in more detail below with reference to FIG. 4E.

Display alignment guide 404 centers the display 402 in the puck assembly 400, especially with respect to the bezel 401. The display alignment guide 404 is mounted to the upper surface of the MCU PCB 405 using alignment bosses 413 inserted into holes 414 of the MCU PCB 405. The display alignment guide 404 may also have standoff bosses 415 extending up from the display alignment guide 404 to support the ring PCB 403 and the display 402.

MCU PCB 405 may be mounted to puck base 407 by way of screws through holes 411 into screw bosses 412. The MCU PCB 405 includes a PIC microcontroller (MCU) 417 mounted to the lower surface of the MCU PCB 405, as shown in FIG. 4B.

Referring back to FIG. 4A, once aligned by the display alignment guide 404, the display 402 may be mounted to the MCU PCB 405 using a double-sided adhesive pad 406 or by other adhesive means.

As FIG. 4A illustrates, the display 402, the ring PCB 403, and the MCU PCB 405 are effectively sandwiched between the bezel assembly 401 and the puck base 407 to form the puck assembly 400. Fasteners, such as screws, inserted through mounting holes in bosses 408 in the puck base 407 pass through slots 410 in the MCU PCB 405 and the ring PCB 403 and into screw bosses 411 (FIG. 4C)) on the underside of the bezel assembly 401.

The puck assembly 400 is preferably attachable and detachable from the mount 350 (FIG. 3C) without having to disconnect the mount 350 or the other token sensor components from the gaming table support surface 205 (FIG. 2). To achieve this purpose, the mount 350 includes threaded standoffs 353 (FIG. 3C) for receiving screws (not shown). The puck base 407 includes two keyholes 421 (FIG. 4D), the circular openings of which accept the heads of the screws threaded into the standoffs 353. Wiring from the electronic components below the gaming table support surface 205, for example, a ribbon cable, is attached to a connector (not shown) on the MCU PCB 405, then the puck assembly is placed above the mount 350 with the round holes in the keyholes 421 aligned with the screw heads. Once the screw heads have been inserted into the keyholes 421, the puck 200 assembly is rotated, for example, by fifteen degrees, to lock the screws into the channels of the keyholes 421 to attach the puck assembly 400 to the mount 350. The puck assembly 400 may be detached from the mount 300 by reversing this procedure. This allows a puck assembly 400 with a scratched or damaged bezel 401, damaged display 402 or malfunctioning electronics to be easily replaced.

FIG. 4E further illustrates components of the Ring PCB 403. Light emitting diodes (LEDs) 415 project visible light up through the bezel 401 to provide feedback to the dealer and player. For example, the LEDs 415 may project green light when a token 260 has been detected on the token sensor 200 and the wager represented by the token 260 has been registered by the system. The token 260 may then by removed from the token sensor 200 while leaving the wager “locked in.” In another example, the LEDs 415 may flash alternating colors during a wagering period in which a token 260 may be accepted by the system or may project red light in cases of an error condition. The LEDs are controlled by the ARM CPU 313 on the control PCB 307. The ARM CPU 313 will be discussed further below.

Continuing with FIG. 4E, light emitters 408 may be any electrically stimulated light-emitting device such as bulbs. LEDs lasers and the like. It is preferred that these light sources have a narrow (less than 100 nm) range of emitted light, and preferably have a range of emitted light that is less than 50 nm, more preferably less than 25 nm and most preferably less than 10 nm in range of wavelengths. In accordance with the embodiments described herein, the emitters 408 preferably emit infrared (IR) light at 940 nm and the detectors 409 are optimized to sense that wavelength. Use of infrared light avoids the problem of prior art token sensors which typically transmit visible radiation, for example red light at approximately 730 nm. When such visible light is used, a translucent bezel is required to avoid any harsh, bright light passing around edges of a token or after a token has been removed, which harsh light might annoy players at the gaming table. Use of infrared light avoids these problems. A non-limiting example of a suitable IR emitter 408 is an Everlight EAISV3024A0, while a non-limiting example of a suitable IR detector is a photo diode such as a Vishay VEMD10949F. Alternatively, a visible light blocking material such as: RTP 0300 in color S-806332, available from RTP Co, Winona, MN can be used.

False readings can be avoided by providing a filter placed between each light emitter 408 and its respective receiver 409 to block all light except the expected range of wavelengths to be sensed. In preferred embodiments, the filter may be incorporated into the receiver 409.

False readings may be further avoided, in some embodiments, but modulating the transmission of light from an emitter 408 to its respective receiver 409 such that it is sent in pulses at an uncommon frequency, which is different from those normally seen in ambient casino lighting, such as 60 Hz, Any, light received by the receiver 409 when it is known that the associated emitter 408 is not emitting light, (i.e., light that is received off frequency) will be ignored. The operation of the light emitters 408 and receivers 409 is controlled by the MCU 417 on the MCU PCB 405. The operation of the MCU 417 will be discussed further below.

The ring PCB 403 optionally includes a gesture sensor 416, the purpose of which will be described further below. An example of a suitable gesture sensor 416 is a Broadcom APDS-9960.

The ring PCB 403 is electrically attached to the MCU PCB 405 by way of pins (not shown) on the ring PCB 403 inserted into a matching connector (not shown) on the MCU PCB. Alternately, a short ribbon cable may be attached to connectors on each of the ring PCB 403 and the MCU PCB 405.

FIG. 4F is a top view of bezel 401 that illustrates light transmission features of the bezel 401. The bezel 401 may be molded from any light-transmitting material, such as glass or polymer, and especially polymeric materials which can be molded, formed and machined, such as polyesters (e.g., LEXAN® polyester), polycarbonates, polyolefins (especially polypropylene, polyethylene and mixtures thereof), thermoplastic polymers and cross-linked polymers.

IR light transmitted from each emitter 408 is focused into its associated detector 409 by opposing column lenses 420. FIG. 4C illustrates the locations of the column lenses 420 molded into the lower surface of the bezel 401. FIG. 4F generally illustrates how non-focused light from emitter 408 is somewhat narrowed by the column lens 420 molded into the bezel 401 adjacent to the emitter 408 and further narrowed by the column lens 420 molded into the bezel 401 adjacent to the detector 409.

FIG. 4G presents a cross section of the bezel 401. It may also be helpful to refer back to FIG. 4C, which shows a view of the lower surfaces of the bezel 401 in which the various components molded into the bezel are identified by like numbers.

The bezel 401 has an upper surface 471 through which the LEDs 415 on the ring PCB 403 may transmit visible light, as described above. The upper surface 471 has a diameter slightly larger than that of the puck base 407, providing a small lip 473 that rests on the top surface of the game layout 302 (FIG. 3). The bezel 401 includes a side wall 474 which, as illustrated in FIGS. 4A and 4C, forms an upper portion of the case of the puck assembly 400, the lower portion being formed by the side wall 424 of the puck base 407 (FIGS. 4A and 4D).

Referring again to FIG. 4G, the bezel 401 further includes a slant window 472. The purpose of the slant window 472 is to protect the components of the ring PCB 403 while allowing the emitters 408 to transmit IR light across the upper surface of the display 402 and to allow the detectors 409 to receive the transmitted IR light when not blocked by a token 460 (aka 260, FIG. 2B). The slant window 472 is slanted to provide a well to receive and center the token 460 and provides for easy removal of the token 460 from the well by, for example, placing finger pressure on the top of the token 460 and sliding the token 460 out of the well.

The cross section of FIG. 4G also shows the location of the screw bosses 411 used for the mounting of the puck base 407 to the bezel 401, as previously described above with reference to FIG. 4C.

If desired, color may be provided in the bezel 401 by dyes or pigments of the desired wavelengths. Embossing, engraving, etching and printing on the bezel 401 may be used to add translucency or opacity in certain areas. Translucency may also be provided by light-scattering particulates or bubbles in the composition of the bezel 401. For example, no treatments may be applied to sections of the slant window 472 adjacent to the column lenses 420 used for the transmission and reception of IR light. Portions of the slant window 472 not used for light transmission and reception may be made opaque to shield the internal components of the puck 200 from view. Finally, some or all of the upper surface 471 may be translucent so light from the LEDs 415 may be seen while still shielding the internal components of the puck 200 from view.

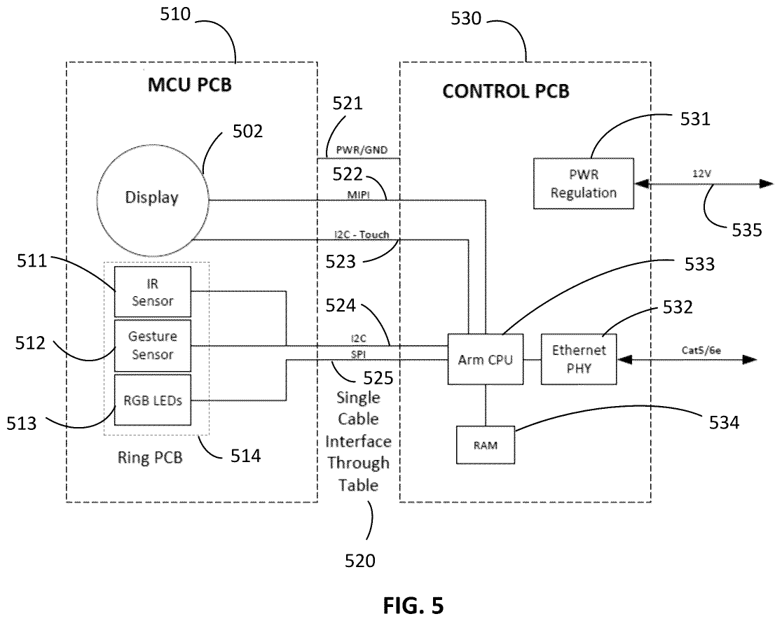

FIG. 5, in accordance with one or more embodiments, provides a block diagram of electrical connections between the various components of the MCU PCB 510 and the components of the ring PCB 514 and the control PCB components 530.

A single cable 520 connects the MCU PCB components 510, contained in the puck 200 mounted above the gaming table support surface 305 (FIG. 3A) and the control PCB components 530 contained in the lower bracket 306 (FIG. 3B) through a hole in the gaming table surface 305. A non-limiting example of a suitable cable would be a ribbon cable with 2×10 connectors. The cable 520 contains power and ground connections 521 between the MCU PCB components 510 and the control PCB components 530, with power originating from a power regulator 531 on the control PCB 530, driven by external 12 v power 535.

The cable 520 further includes an MIPI DSI video display interface between the ARM CPU 533 and the display 502 that carries data for controlling text and images on the screen of the display 502. In embodiments that include a touchscreen as part of the display 502, an I²C connection 523 carries touch data to the ARM CPU 533. The infrared sensor section 511, which includes the emitters 408, detectors 409 and the gesture sensor 416 (FIG. 4E) of the ring PCB components 514, sends and receives data to and from the ARM CPU 533 via a second I²C connection 524. An SPI connection 525 between the ARM CPU 533 and the RGB LEDs 513 completes the signals carried by the cable 520.

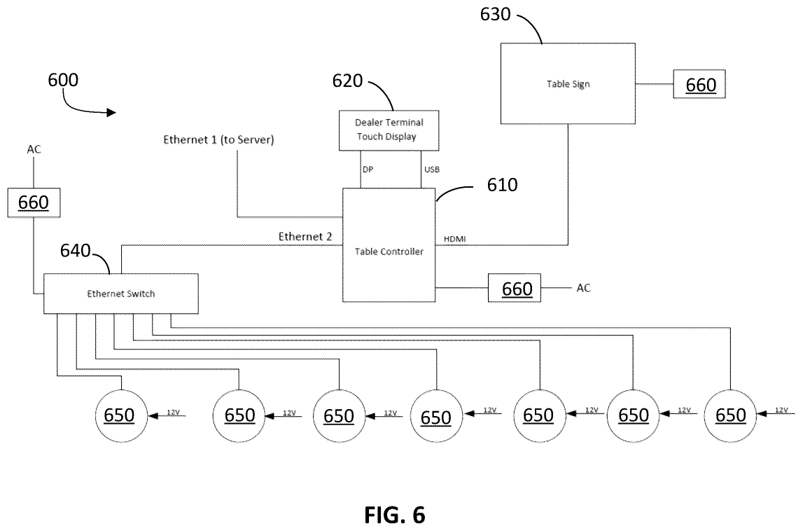

FIG. 6, in accordance with one or more embodiments, provides a block diagram of connections between various components for a gaming table 600 similar to the gaming table 102 described above with reference to FIG. 1. Table controller 610, which may be, for example, a Nexus Command II Table Controller manufactured and sold by Light and Wonder, Inc., is connected via USB and DisplayPort connections to a dealer terminal 620, which for example, may include an LCD display panel with a touchscreen input, one or more separate buttons, etc. The table controller 610 is also connected to a table sign 630 via an HDMI cable. The table sign 630 is typically a video display monitor used to graphically display game title, wagering limits, progressive award information, bonus game displays, animations and the like. The HDMI cable to the table sign 630 may also include audio content playable through audio components, such as an amplifier and speakers, of the table sign 630. The table controller 610 is also connected via a first ethernet connection to a remote central game/progressive server, for example, the GM Atlas system mentioned above. A second ethernet connection communicatively couples the table controller 610 to an ethernet switch 640. The ethernet switch 640 serves as a centralized connection point for the token sensors 650 and provides a communication link between the table controller 610 and the token sensors 650. The table controller 610, the dealer terminal 620, the table sign 630 and the ethernet switch 640 are typically powered by alternating current power supply units 650. The token sensors are typically powered by 12 vdc supplied by a direct current power distribution hub (not shown) also connected to a power supply unit 650.

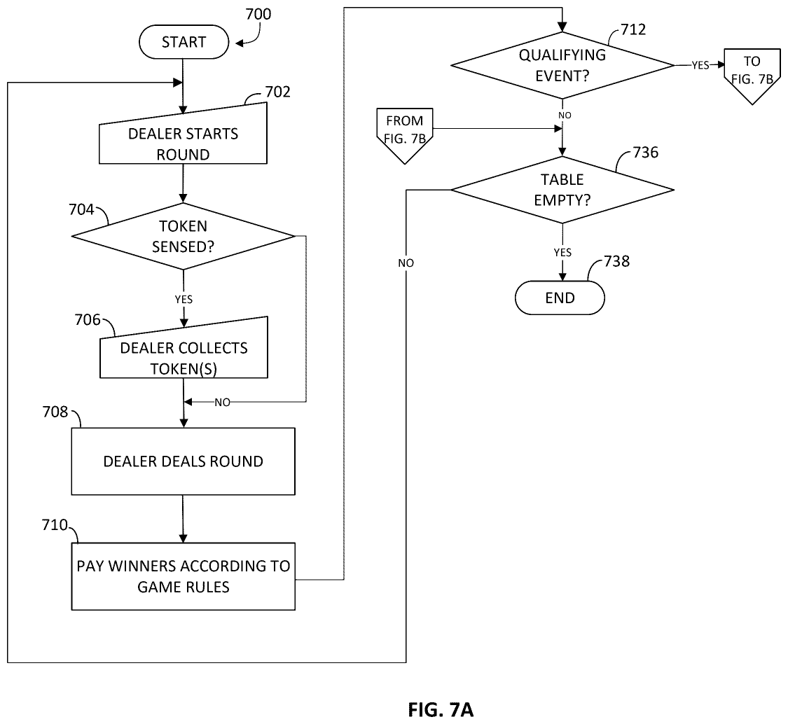

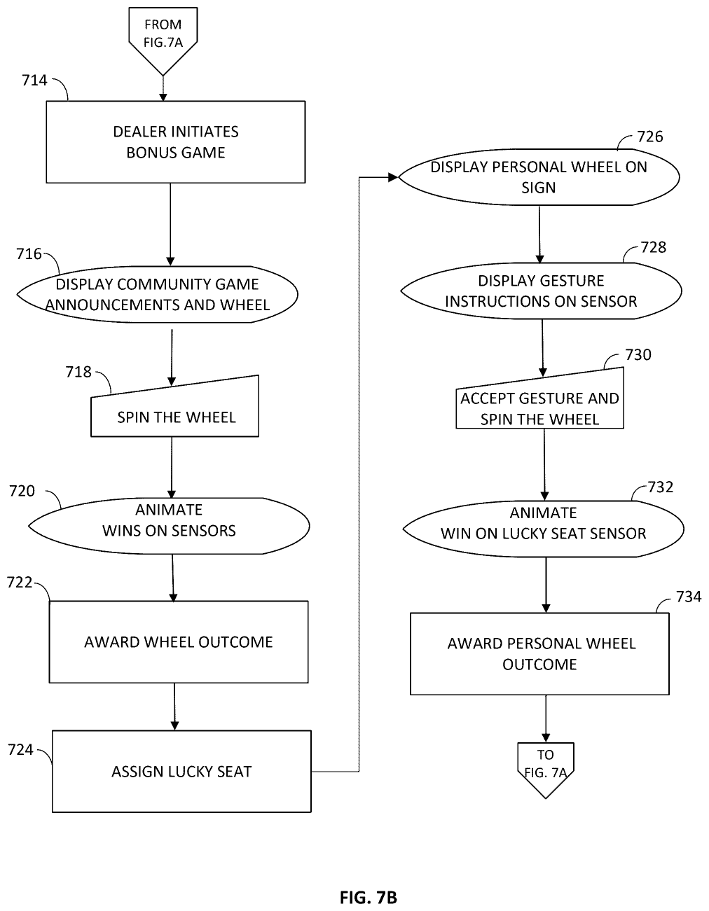

Referring now to FIGS. 7A-7B, there is shown a flow diagram representing one data processing method 700 corresponding to at least some instructions stored and executed by the table controller 610 of FIG. 6 to perform operations of an exemplar use case of the present invention. The data processing method 700 relates to a table game including a community bonus game and a secondary personal bonus game. Various elements of FIG. 6 will be referenced in the description of FIGS. 7A-7B.

At step 702, the dealer starts a game round. The dealer may enter a command on the dealer terminal touch display 620 to indicate to the table controller 610 that the game round has begun. In response, the table controller 610 may announce the start of the game round on the table sign 660 and on each of the displays of the token sensors 650. For example, the token sensor displays may display instructions for placing a bonus game wager: “Place a token here for a chance to win $30,286.50!” Optionally, a countdown timer indicating how long the bonus game wagering period will be in effect may be displayed. The token sensors 650 may also be commanded to flash their upward facing LEDs in a particular color, for example, green. Each token sensor receiving a token on its surface will transmit that information to the table controller 610, which may then command the token sensor to change the color of the LEDs to acknowledge the presence of the token, for example, to orange. At the conclusion of the wagering period, the table controller may display, “No More Bets” on the displays of the token sensors 650 and change the color of their LEDs to red.

At step 704, if no bonus game wagers were placed, the flow continues to step 708. Otherwise, one or more tokens have been sensed on the token sensors 650 and, at step 706, the tokens are collected from the token sensors 650 by the dealer into the chip tray 140 (FIG. 1). The table controller 610 monitors the token sensors 650 for removal of the tokens and “locks in” the bonus game wager for each respective table position as its token is removed. The table controller 610 may turn the token sensor LEDs at “locked in” table positions to green and those without a bonus game wager to another color or to off. The table controller 610 notifies the server of each locked in bonus game wager for the purposes of incrementing the progressive award.

At step 708, the dealer deals the game round, for example, by removing and distributing cards from the card handling device 180 (FIG. 1) according to the rules of the game being played.

At step 710, the dealer pays any winning hands according to the game rules for the game being played.

At step 712, the dealer indicates whether the dealt cards represent a qualifying event for the triggering of a bonus game. For example, in a game of blackjack, the qualifying event may be that the dealer has a blackjack.

Depending on the game being played at the gaming table, any combination, or lack thereof, of dealer and/or player cards may be specified as a qualifying event. In accordance with some embodiments, the table controller may simply, once the tokens have been collected at step 704, randomly determine that a bonus game will be played. Thus, approximately the same odds of a qualifying event may exist at gaming tables with different game rules. By specifying the same probability of a qualifying event, whether determined by the dealt cards or by the table controller 610, common progressive awards may be shared by dissimilar games.

If there is no qualifying event at step 712, the game round is over and the flow proceeds to step 736. However, if there is a qualifying event at step 712, the flow proceeds to step 714 of FIG. 7B.

At step 714, the dealer starts the bonus game. As in step 702, the dealer may enter a command on the dealer terminal touch display 620 to indicate to the table controller 610 that the bonus game has begun.

At step 716, in response, the table controller 610 may announce the start of the bonus game on the table sign 660. Each token sensor with a wager locked in at step 704 may display “You are entered in the Community Bonus Game!” and be commanded to flash their upward facing LEDs in a particular color, for example, white. Each token sensor at a position where a wager was not locked in may alternately display a different message, for example, “Not Eligible for the Community Bonus Game”, with the LEDs off.

In this example, the bonus game includes a prize wheel which is also displayed on the table sign 660 at step 716.

At step 718, the dealer initiates an animated spin of the displayed bonus wheel by entering a command on the dealer terminal touch display 620. The wheel displayed on the table sign 660 is then animated to produce a randomly selected, via a random number generator in the table controller 610, a prize amount from amounts displayed on the wheel.

The winning amount is displayed on the display of each of the token sensors at the participating seats at step 720. The token sensor LEDs may also be commanded to flash in celebration.

At step 722, the randomly selected wheel outcome is paid to all seats participating in the bonus game.

At step 724, the table controller 610 randomly determines a “lucky seat” from the positions at the gaming table with locked in bonus game wagers. The lucky seat position may be displayed on the table sign 660.

At step 726, the bonus wheel on the table sign 610 may be repopulated and displayed as a “personal wheel” with different prize values for the personal round of the bonus game. In some embodiments, the values may stay the same. In preferred embodiments, the personal wheel values include one or more progressive awards.

At step 728, the game controller 610 also displays instructions on the display of the token sensor at the lucky seat table position. For example, a message such as “You Have the Lucky Seat!Press Here to Spin the Wheel!” may be displayed. Again, the LCDs may also be animated, for example, by changing colors or flashing. The instructions may instruct the player to perform a more complex gesture or touch detectable by the token sensor using the gesture sensor, the touch zones determined by the emitters/detectors or the optional touchscreen, as described above. For example, the player may be asked to run their finger around the inner wall of the well of the token sensor to simulate a spinning motion.

At step 730, the system waits for the player to make the instructed gesture. The token sensor determines when the required gesture has been made and sends this information to the table controller 610, which accepts the gesture. A spin of the personal wheel is then animated on the table sign 660. In some embodiments, the personal wheel may also be displayed and animated on the token sensor display at the lucky seat.

At step 732, the amount of the randomly determined personal prize is displayed on the table sign 660 and on the display of the token sensor at the lucky seat. The token sensor LEDs may be commanded flash in celebration.

At step 734, the dealer pays the player at the lucky seat according to the randomly selected personal wheel outcome. Flow then returns to step 736 of FIG. 7A.

At step 736, if at least one player remains at the table, the flow continues to step 702, where the dealer starts another game round as described above. If no players remain at the table, the method concludes at step 738.

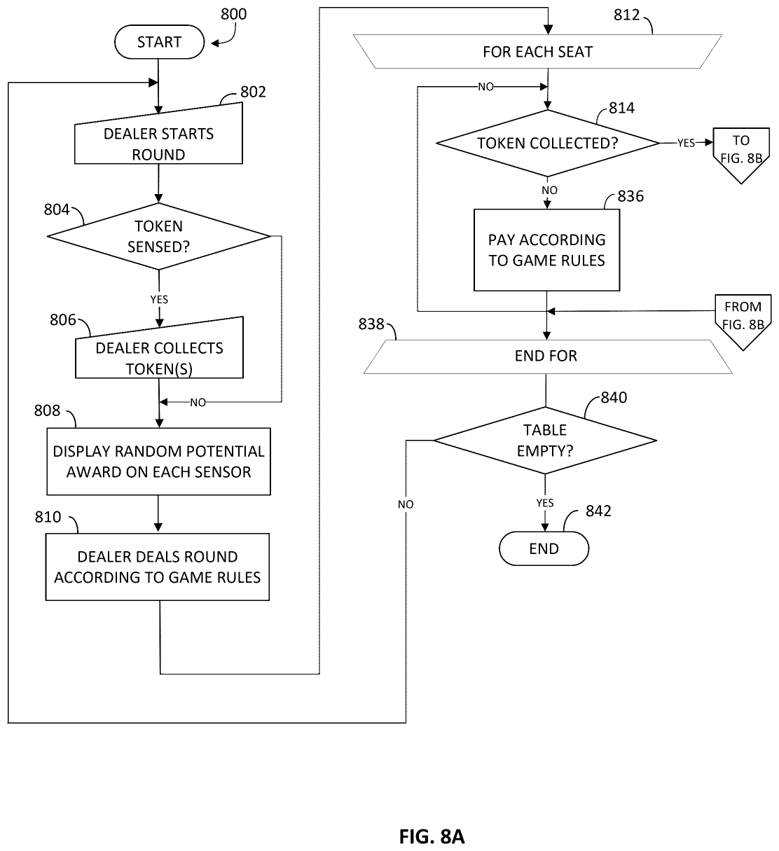

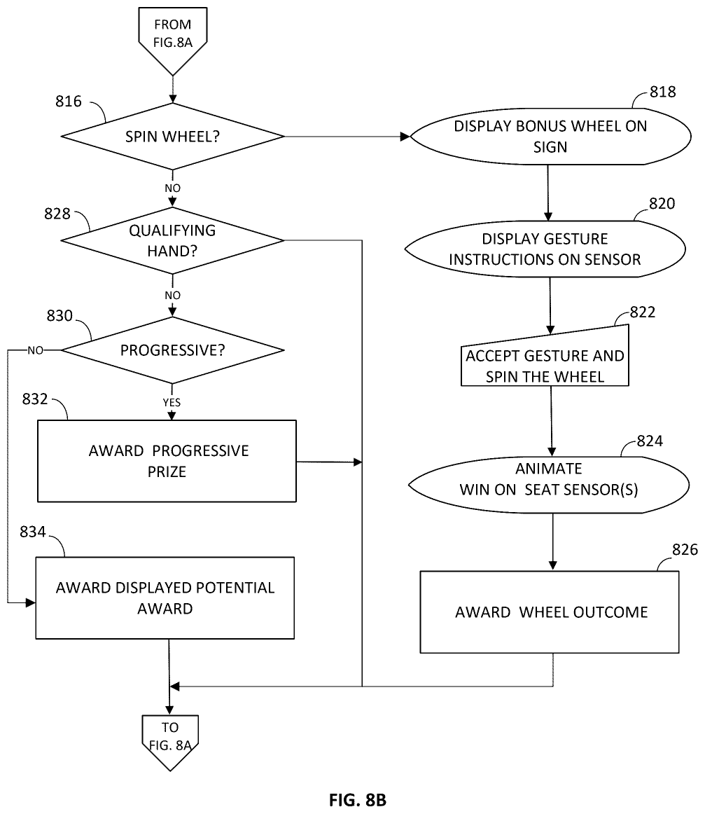

Referring now to FIGS. 8A-8B, there is shown a flow diagram representing one data processing method 800 corresponding to at least some instructions stored and executed by the table controller 610 of FIG. 6 to perform operations of an exemplar use case of the present invention. The data processing method 800 relates to a table game including a community bonus game and a secondary personal bonus game. Various elements of FIG. 6 will be referenced in the description of FIGS. 8A-8B.

At step 802, the dealer starts a game round. The dealer may enter a command on the dealer terminal touch display 620 to indicate to the table controller 610 that the game round has begun. In response, the table controller 610 may announce the start of the game round on the table sign 660 and on each of the displays of the token sensors 650. For example, the token sensor displays may display instructions for placing a bonus game wager: “Place a token here for a chance to win $30,286.50!” Optionally, a countdown timer indicating how long the bonus game wagering period will be in effect may be displayed. The token sensors 650 may also be commanded to flash their upward facing LEDs in a particular color, for example, green. Each token sensor receiving a token on its surface will transmit that information to the table controller 610, which may then command the token sensor to change the color of the LEDs to acknowledge the presence of the token, for example, to orange. At the conclusion of the wagering period, the table controller may display “No More Bets” on the displays of the token sensors 650 and change the color of their LEDs to red.

At step 804, if no bonus game wagers were placed, the flow continues to step 808. Otherwise, one or more tokens have been sensed on the token sensors 650 and, at step 806, the tokens are collected from the token sensors 650 by the dealer into the chip tray 140 (FIG. 1). The table controller 610 monitors the token sensors 650 for removal of the tokens and “locks in” the bonus game wager for each respective table position as its token is removed. The table controller 610 may turn the token sensor LEDs at “locked in” table positions to green and those without a bonus game wager to another color or to off. The table controller 610 notifies the server of each locked in bonus game wager for the purposes of incrementing the progressive award.

At step 808, the table controller 610 randomly determines a potential award for each position at the gaming table.

The potential award for each seat is displayed by its token sensor. In embodiments, a graphic representing the table may displayed on table sign 660 with each respective potential award displayed at the location of each seat position on the graphic.

In some embodiments, the displayed potential award for seats without locked in bonus game wagers may be greyed out or some other indication made that the potential award associated with those seats cannot be won. This encourages players to place bonus game wagers in the future.

In some embodiments, potential awards may be determined and displayed only for seats associated with locked in bonus game wagers. No display of potential awards is shown for seats without locked in bonus game wagers.

The potential award may be a spin of a bonus wheel, similar to the “personal wheel” described above in the description of method 700. The potential award may be one of one or more progressive awards associated with the game. The associated bet sensor may display the amount of the progressive award or identify it by title, for example, “MINI,” “MINOR,” “MAJOR” or “MAX,” to associate the potential award with titled progressive meters displayed on the table sign 660. The potential award may be a pay modifier such as a multiplier (2×, 10×, 20×, 100×, etc.) or an additional monetary value. If the hand at the seat results in a win, the win amount associated with the winning hand in accordance with the rules of the game will be enhanced by the pay modifier. Other randomly determined potential awards fall within the scope and spirit of the invention. In some embodiments, the potential awards may be selected from different tables or ranges depending on how many bonus game wagers have been placed in a given round.

At step 810, the dealer deals the game round, for example, by removing and distributing cards from the card handling device 180 (FIG. 1) and determining winning hands according to the rules of the game being played.

At step 812, the method begins an iterative “for loop” to award payment for each seat with a winning outcome.

At step 814, if the current seat being addressed did not have a token collected at step 806 in response to the placement of a bonus wager, flow continues at step 836, where the dealer pays any winning hands according to the game rules for the game being played. At step 838, if there is another seat in the “for loop,” flow returns to step 814. Otherwise, the “for loop” ends at step 838 and flow continues at step 840, described below.

If, however, at step 814, the current seat being addressed had a token collected at step 806 in response to the placement of a bonus wager, flow continues at step 816 of FIG. 8B.

### Scenario 1—Spin of a Bonus Wheel Without the Need for a Qualifying Hand

At step 816, if the potential award displayed at the current seat is the spin of a bonus wheel, flow continues to step 818. In this embodiment, any winning hand is eligible for this award. In alternate embodiments, only a “qualifying” winning hand is eligible for this award, as will be described below with respect to other types of potential awards.

At step 818, a bonus wheel, if not already displayed on the table sign 610, may be displayed on the table sign 610. The bonus wheel may be populated with different prize values such as, for example, cash prizes, progressive awards or multipliers. In preferred embodiments, the wheel prize values include one or more progressive awards.

At step 820, the game controller 610 also displays instructions on the display of the token sensor at the current table position. For example, a message such as “Press Here to Spin the Wheel!” may be displayed. The LCDs may also be animated, for example, by changing colors or flashing. The instructions may instruct the player to perform a more complex gesture or touch detectable by the token sensor using the gesture sensor, the touch zones determined by the emitters/detectors or the optional touchscreen, as described above. For example, the player may be asked to run their finger around the inner wall of the well of the token sensor to simulate a spinning motion.

At step 822, the system waits for the player to make the instructed gesture. The token sensor determines when the required gesture has been made and sends this information to the table controller 610, which accepts the gesture. A spin of the wheel is then animated on the table sign 660. In some embodiments, the wheel may also be displayed and animated on the token sensor display at the current seat or at all seats.

At step 824, the amount of the randomly determined wheel prize is displayed on the table sign 660 and on the display of the token sensor at the current seat or at all seats. The token sensor LEDs may be commanded to flash in celebration.

At step 826, the dealer pays the player at the current seat according to the randomly selected wheel outcome. This payment may be in addition to, or may replace, the award dictated by the rules of the game. Flow then returns to step 838 of FIG. 8A.

### Scenario 2—A Potential Award Requiring a Qualifying Hand

If the potential award at step 816 was not a spin of a bonus wheel, a qualifying winning hand is required to win the displayed potential award.

Step 828 determines whether the hand at the current seat represents a qualifying hand for awarding of the displayed potential award for the current seat. For example, in a game of blackjack, a qualifying winning hand may be a blackjack, a suited blackjack, etc. In some embodiments, depending on the game being played at the gaming table, any combination, or lack thereof, of dealer and/or player cards may be specified as a qualifying hand.

If there is no qualifying hand at the current seat, flow returns to step 838 of FIG. 8A, otherwise flow continues at step 830.

At step 830, if the displayed potential award is a progressive award, the progressive award displayed on the token sensor at the current seat is awarded to the player at the current seat at step 832. Flow then continues at step 838 of FIG. 8A.

If, however, at step 830, the displayed potential award is not a progressive award, the displayed potential award is awarded instead at step 834. For example, if the displayed potential award is a modifier, the win amount associated with the hand in accordance with the rules of the game will be enhanced by the pay modifier and the resulting award is paid to the player at the current seat at step 834. Flow then continues at step 838 of FIG. 8A.

As described above, if there is another seat in the “for loop,” at step 838, flow returns to step 814. Otherwise, the “for loop” ends at step 838 and flow continues at step 840.

At step 840, if at least one player remains at the table, the flow continues to step 802, where the dealer starts another game round as described above. If no players remain at the table, the method concludes at step 842.

### A Blackjack Use Case

One of the most popular table games is the card game known as Blackjack (or “21”) wherein a blackjack player plays against a dealer and the object is to beat the dealer's hand by reaching a total point value closest to 21, without exceeding a point count of twenty-one and/or by having the dealer's point count exceed twenty-one. The player may exercise strategies including adjusting his point count either by maintaining his original cards and card count (e.g., referred to as “standing,” not drawing a card that might cause the Blackjack player to ‘bust, that is go over 21) and hope that the dealer will bust or by accepting additional cards (referred to as ‘hitting’ or ‘taking a hit’), attempting to receive a cumulative point card total higher (not exceeding a total point count of 21) than the total point count that the dealer will ultimately attain. If both the Blackjack player and the dealer each achieve a point count total that does not exceed 21, then the highest total (as between individual players and the dealer) wins the bet. Blackjack is relatively simple to understand and is usually a faster and easier card game to play than, for example, the game of Poker. Therefore, Blackjack, which can be played with the dealer and only one Blackjack player, tends to be more popular than the conventional game of Poker which needs to be played with several players because each of the Poker players are competing against each other for one pot whereas each Blackjack player can win against the one dealer. Even with variants of poker being played in casinos (e.g., Let It Ride® poker, Three Card Poker®, Crazy 4 Poker™, Caribbean Stud® poker, etc.), Blackjack remains the most popular card game in casinos, with many more tables usually dedicated to blackjack than to all other card games combined.

Blackjack must include a dealer (in mechanical, electromechanical, electronic or video versions of the game, a virtual dealer's hand is provided) and there must be at least one Blackjack player. One or more Blackjack players playing against the dealer are, in effect, individually competing to try to either obtain a better total card point count than the point count of the dealer, without exceeding a total point count in the player's hand of 21 (for the total number of multiple playing cards that they are dealt). The player may stand after receiving a minimum of two cards and hope that the dealer will bust. There are many variants on strategies that are used in the play of cards that are dependent upon a consideration of the player's cards in comparison with the dealer's cards. There are preferred and optimal strategies that may be used, with some strategies possibly influenced by card counting by the player.

For example, Blackjack players seeing a dealer's exposed card as a 2, 3, 4, 5 or 6, will themselves elect to take no hits when the player's point count is 12, 13, 14, 15 or 16 in the hopes that the dealer's hitting (which is required when the dealer's point count is 16 or less) will result in a bust. The objective of the player is that with the exposed card being generally incapable of having a starting point count where the dealer may stand (the exception being a disclosed card of a 6 and a hole card of an ace), the dealer will take hits to a point total that exceeds 21 and therefore break (or “bust”), allowing the player to win the hand. The player will win the bet if the dealer has to hit (the dealer is required to draw if their point total is 16 or less) and the dealer busts (goes over 21). Blackjack players also have the option of splitting any pairs (i.e., a pair of cards of identical point count value, such as two face cards, a 10 and a face card, a pair of 10s, a pair of 9s, a pair of 3's, etc.). Blackjack players have several options such as to double down (double their bet and receive only one more card), double their bet when they split a pair of cards, and can receive a 1.5 times their bet return if they receive a blackjack, which is an Ace and a 10 or picture card for their other card. A Blackjack player receiving a card score of more than 21 points has a bust hand and automatically loses to the dealer. If the dealer accumulates cards with a point count in excess of 21, the dealer busts, and every player remaining in the game (those players who have not busted themselves) wins the hand. The dealer, after receiving the first two cards begins drawing one or more cards (if the first 2 cards are 16 or less), but only after each of the Blackjack players at the dealer's table have played their hands to completion. Therefore, the house or casino has the advantage because the Blackjack player or players must play and complete their hand first or before the dealer plays or completes his hand. The Blackjack players at the table individually play against the dealer. The dealer must receive a minimum of two cards and attain a point count of at least 17 before the dealer may stop taking cards. Each of the Blackjack players individually playing against the dealer (who is a representative of the house or casino) has the option of standing after the receipt of their two initial cards. This means that the player will have the options of not receiving any other cards or to draw one or more other cards from the dealer and to continue drawing cards until the player is either satisfied with their card count score and stops drawing cards (stands) or the player has busted (gone over the 21-point total). As is known in the Blackjack card game, picture cards (Jacks, Queens and Kings) each have a point card value of 10 points while Aces have a point card value of either 1 point or 11 points. The other cards, namely 2s, 3s, 4s, 5s, 6s, 7s, 8s, 9s and 10s, have a point card value equivalent to their face card value (i.e., respectively 2, 3, 4, 5, 6, 7, 8, 9, and 10). In most gaming or casino establishments, dealers have to draw when they receive a point card value of 16 or less and, in some Casinos or gaming establishments, when they receive a point card value of 17 or less where the 17 point card value is based upon using an Ace as an 11 point card value with one or more other cards (this is known as a “soft 17”).

While Blackjack or 21 is a relatively fast-playing card game, it is always desirable to offer the players opportunities for variations in the game to maintain their long-term interest.

In a variation of Blackjack described below, the regular rules of Blackjack are modified as follows:

The dealer receives the first dealer card face down.

The player receives their first card face up.

The dealer receives the second dealer card face up.

Insurance pays 2-1

No even money insurance option.

No splitting of pairs.

No surrender option.

The player receives only one extra card if the player's first card is an Ace.

A player's suited blackjack pays 3-1, an unsuited blackjack pays 1.5-1.

dealer must hit with a “soft 17.”

Especially unique to this variation of Blackjack is that the Player may double down multiple times in a given round of play at any point where the player can make a decision to take another card.

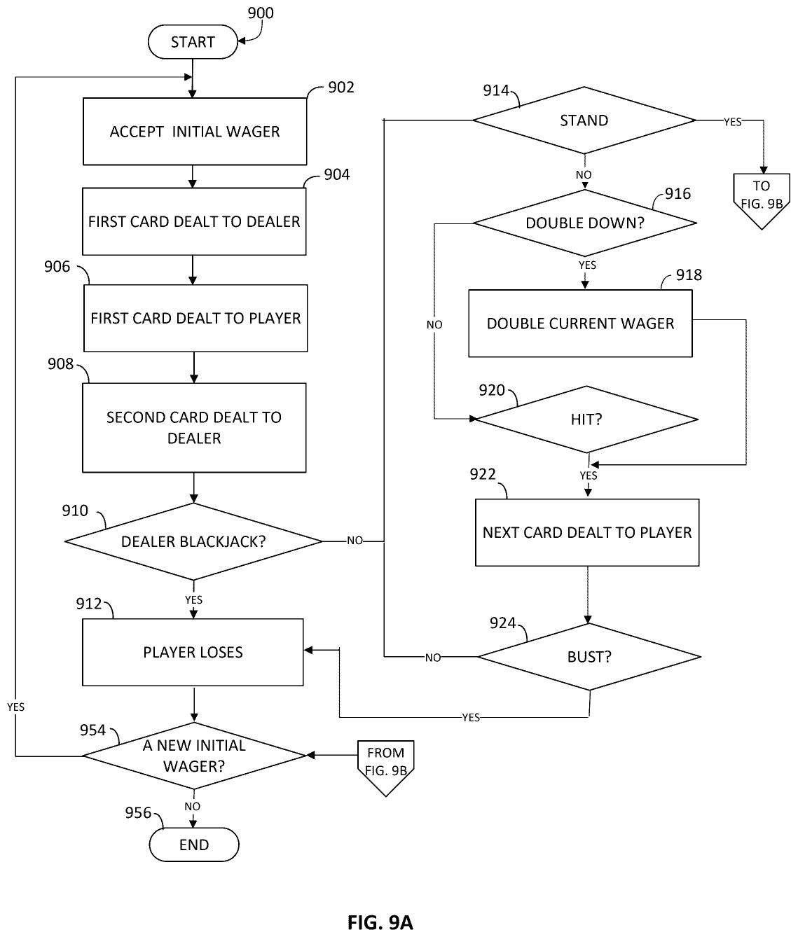

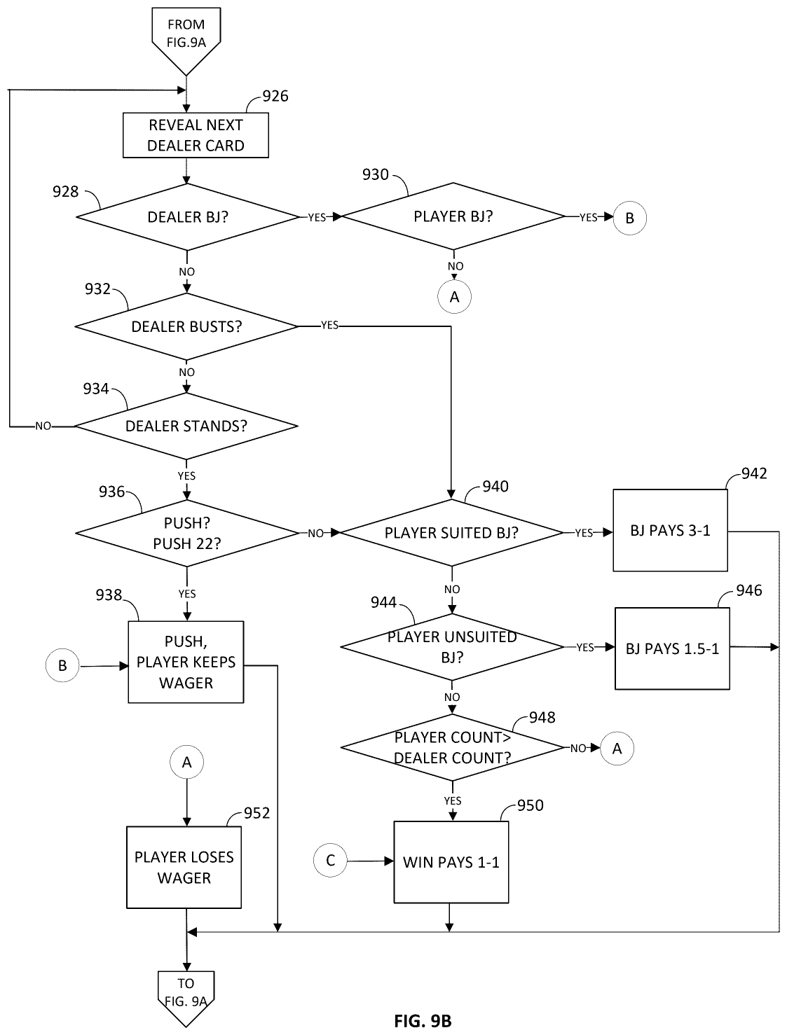

Referring now to FIGS. 9A-9B, there is shown a flow diagram representing one method corresponding to the play of such a game. For simplicity's sake, the diagram assumes a dealer and a single player, though the method applies equally to multiple players at a single gaming table, as described above. In these multi-player cases, all actions ascribed to the player in FIG. 9A are performed sequentially by each player at the table, then the dealer actions detailed in FIG. 9B are performed.

Step 900: The method begins at this step.

Step 902: The dealer accepts an initial wager from the player.

Step 904: The dealer receives the first card face down.

Step 906: The player receives their first card face up.

Step 908: The dealer receives the second dealer card face up.

For simplicity's sake, insurance is not included in the details of FIGS. 9A-9B. However, if the dealer's second card (the dealer's up card) is an Ace at step 908, the dealer offers the player the option to place an insurance wager. As noted in the rules above, no “even money” option, where the player places an additional insurance wager half of the size of their original wager, is offered in this embodiment. If the dealer ultimately has a blackjack, the player will lose their initial wager, but will win the insurance wager. In the example here, as is typical in regular Blackjack, insurance pays 2-1. In other embodiments, insurance may pay another amount.

Step 910: If the dealer's second card is a face card or an Ace, the dealer checks the face down “hole card” to see if the dealer's hand is a blackjack.

Step 912: If the dealer has a blackjack at step 910, the player loses the initial wager. If an insurance wager was made, insurance pays 2-1, resulting in a financial tie for the player. The round is over. Flow continues at step 954.

Step 914: If the dealer does not have a blackjack at step 910, the player decides whether to stand based on their current point count. If the player chooses to stand, no more cards are dealt to the player and the flow proceeds to step 926 of FIG. 9B, described below.

Steps 916-918: If the player elects not to stand at step 914, the player may instead opt to double down. If the player so elects, an additional wager equivalent to the current size of the player's wager is made at step 918, doubling the size of the current wager. For example, an initial wager of $10 increases to $20.

Step 920: If the player has not decided to stand or double down in steps 914 and 916, the player may hit to receive another card.

Step 922: If the player opted to double down at step 914 or to hit at step 918, the player receives another card and their point count is recalculated.

Step 924: If the player's point count exceeds 21, the player's hand busts and flow proceeds to step 912. If the player's point count does not exceed 21, flow instead proceeds to step 914, where the player makes a new stand, double down or hit decision based on the new point count.

### Player Stands—Dealer Actions (FIG. 9B)

Step 926: The dealer's next card is revealed. This may be the result of the dealer turning over their hole card or of the dealer taking a hit according to the rules of the game.

Step 928: Upon the dealer revealing their hole card, it is determined whether the dealer has a blackjack. If so, flow proceeds to step 930. If not, flow proceeds to step 932.

Step 930: Because the dealer has a blackjack, it is determined whether the player also has blackjack. If not, this is a player loss and flow proceeds to step 952. If the player does have a blackjack, this is a tie, commonly known as a “push,” and flow proceeds to step 938.

Step 932: At this step, neither the dealer nor the player had a blackjack. This step determines whether the dealer's hand busted. Normally, in the game of regular Blackjack, any point total of 22-26 is considered a “bust” hand. Having one or more of these dealer totals treated instead as a “push” creates an extra edge for the casino, which can be used to compensate for non-standard lucrative opportunities offered to the player such as, in these embodiments, the chance to double down at any, decision point and/or to receive 3-1 for a suited blackjack. These concepts are disclosed in U.S. Pat. No. 7,435,172 (Hall), incorporated herein by reference in its entirety. In the embodiments described here, a dealer's point total of 22 is considered a push. (As in regular Blackjack, any player's point total over 21 is a bust for the player.) If the dealer's hand busted, flow continues at step 940. If the dealer's hand did not bust, the flow continues at step 934.

Step 934: At this step, if the dealer's point count is greater than or equal to 17, excluding a “soft 17,” the dealer must stand, with flow continuing at step 936. Otherwise, the dealer must hit, with flow returning to step 926.

Step 936: At this step, if the dealer's point count and the player's point count are equal, the result is a push. In these embodiments, this step also checks to see if the dealer's point count is equal to 22, which, as described above, is also a push. If a push situation does not exist, flow continues at step 940, otherwise flow continues at step 938.

Step 938: The player and dealer outcomes resulted in a push. The player keeps the wager. Flow continues at step 954 of FIG. 9A.

Step 940: The dealer and player outcomes did not result in a push. This step determines whether the player had a suited blackjack, which qualifies for an enhanced award. If so, flow continues at step 942, otherwise flow continues at step 944.

Step 942: At this step, because the player's hand was a suited blackjack, the player is paid 3-1, the round is over, and flow continues at step 954 of FIG. 9A.

Step 944: This step determines whether the player had an unsuited blackjack. If so, flow continues at step 946, otherwise flow continues at step 948.

Step 946: At this step, because the player's hand was an unsuited blackjack, the player is paid 1.5-1, the round is over and flow continues at step 954 of FIG. 9A.

Step 948: At this step, the player's point count is compared to the dealer's point count. If the player's point count exceeds that of the dealer, the player wins with flow continuing at step 950. Otherwise, the player loses and the flow continues at step 952.

Step 950: At this step, the player wins an amount equal to the total wager (the initial wager and any additional double down wagers). The round is over and flow continues at step 954 of FIG. 9A.

Step 952: At this step, the player loses the total wager (the initial wager and any additional double down wagers). The round is over and flow continues at step 954 of FIG. 9A.

Step 954: At this step, the round has concluded. The player has the chance to start a new round by placing another initial wager. If the player places another wager, flow returns to step 902 to repeat the method outlined above. Otherwise, the method terminates at step 956.

The following descriptions will assist in further illustrating the above method of playing the game of the invention. It is assumed that there is a dealer and only one player at a gaming table. The dealer deals from a randomly shuffled set of four decks of cards. The player places an initial wager of $10. The dealer deals initial hands of blackjack in the sequence described above, one card at-a-time: a first card to the dealer (face down), a first card (face up) to the player, and a second card (face up) to the dealer. Decisions are then made according to the rules of the game. Basic Blackjack strategy assumes that the dealer hole card is a high card, typically with a point value of 10 and that the player's next card will also be a high card. These assumptions drive the player's decisions to stand, hit or double down. The hands are dealt are as follows in a series of game plays, as described below.

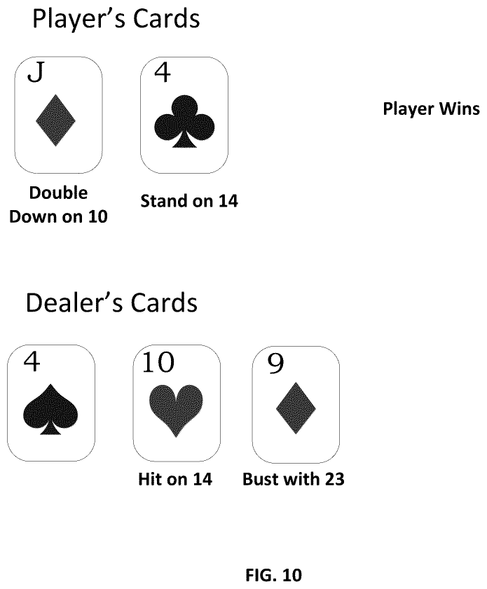

FIG. 10 and the following description illustrate all of the cards dealt in a first example round and indicate the action taken upon receipt of each of the cards by the player and the dealer.

### Player Actions:

Dealer Hand: 4 face up, hole card unknown, but a 10-value card is assumed.

Player Hand: J

There is no possibility of busting on the first card, so there is no reason for the player to stand with an initial Jack. Hitting is possible in this situation, since the player cannot bust, but the dealer appears to have a hand likely to bust if there is indeed a 10-value card in the hole. The player also has a point count of 10, likely to result in a very good hand after the next card. Double down is the best option. The player's wager doubles to $20.

Player Hand: J, 4

The player has been dealt a 4 as the second card for a point count of 14. A point count of 14 is very weak; taking another card is likely to bust. Since the dealer also appears to have a hand likely to bust, standing is the best option. The wager remains $20.

### Dealer Actions:

Player Hand J, 4

Dealer hand 4, 10 (hole card revealed)

The dealer's revealed hole card supports the player's decisions. The dealer has a point count of 14 and is likely to bust. The game rules require the dealer to hit with a point count of 14.

Dealer hand 4, 10, 9

The dealer's third card is a 9 for a point count of 23. The dealer busts, as expected, and the player wins $20.

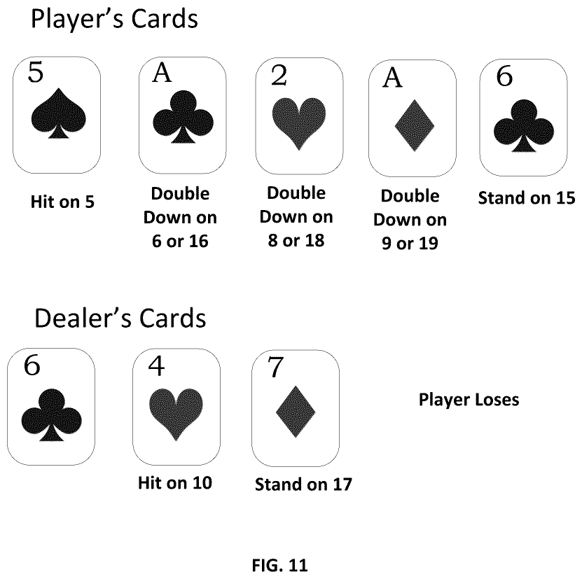

FIG. 11 and the following description illustrate all of the cards dealt in a second example round and indicate the action taken upon receipt of each of the cards by the player and the dealer.

### Player Actions:

Dealer hand 6 face up, hole card unknown, but a 10-value card is assumed.

Player Hand 5

The dealer's anticipated hand has a point count of 16, assuming there is a 10-value card in the hole card position. Thus, the expectation is that the dealer will bust. Even with a weak initial card for the player, the player elects to double down and increases the wager to $20.

Player Hand 5, A

The player's second card is an Ace, resulting in a point count of 6 or 16. Even though both of these point counts are poor, the player cannot bust by taking another card. Against the dealer's extremely weak 6, the player doubles down again and increases the wager to $40.

Player Hand 5, A, 2

The player's third card is a deuce, resulting in a point count of 8 or 18. This is a very strong hand against the dealer's 6. Since the player cannot bust and the strategy is really to increase the wager as much as possible in anticipation of the dealer busting, the player doubles down again. The player's wager increases to $80.

Player Hand 5, A, 2, A

The player's fourth card is another Ace, resulting in a point count of 9 or 19. This is, again, a very strong hand against the dealer's 6 and the player doubles down again. The wager increases to $160.

Player Hand 5, A, 2, A, 6

The player's fifth card is a 6, resulting in a point count of 15. This is now a weak hand, so the player stands and hopes that the dealer will bust. The wager remains $160.

### Dealer Actions:

Dealer hand 6, 4 (hole card revealed)

The dealer's revealed hole card is a 4, resulting in a point count of 10. The game rules require the dealer to hit with a point count of 10, so another dealer card is dealt.

Dealer hand 6, 4, 7

The dealer's third card is a 7 for a point count of 17. Since no Ace is involved, which would require the dealer to hit a “soft 17,” this is a “hard 17” and the dealer must stand according to the rules of the game. The dealer's point count of 17 exceeds the player's final point count of 14 and the player loses $80.

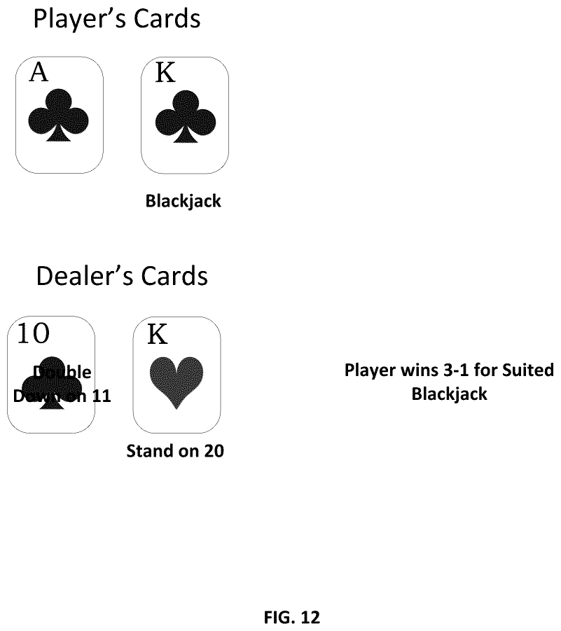

While not described here in as much detail, FIGS. 12-15 similarly illustrate the cards dealt in third, fourth, fifth and sixth example rounds and indicate the action taken upon receipt of each of the cards by the player and the dealer and the game outcomes according to the flow of FIGS. 9A-9B.

FIG. 12 illustrates that the player is paid 3-1 for a suited blackjack when the dealer does not also have a blackjack or a point count of 22, both of which would result in a push.

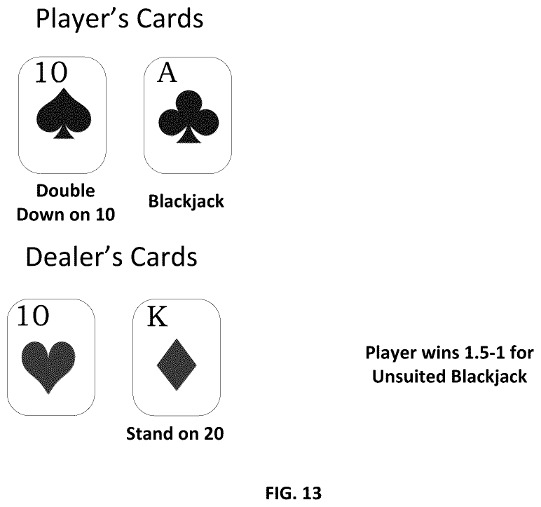

FIG. 13 illustrates that the player is paid 1.5-1 for an unsuited blackjack when the dealer does not also have a blackjack or a point count of 22, both of which would result in a push.

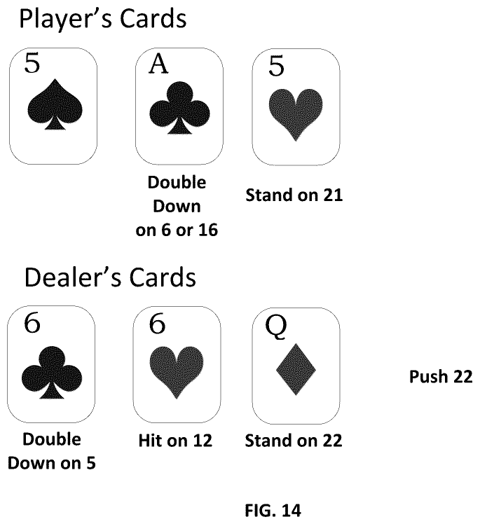

FIG. 14 illustrates that a push results from the dealer drawing to a final point count of 22.

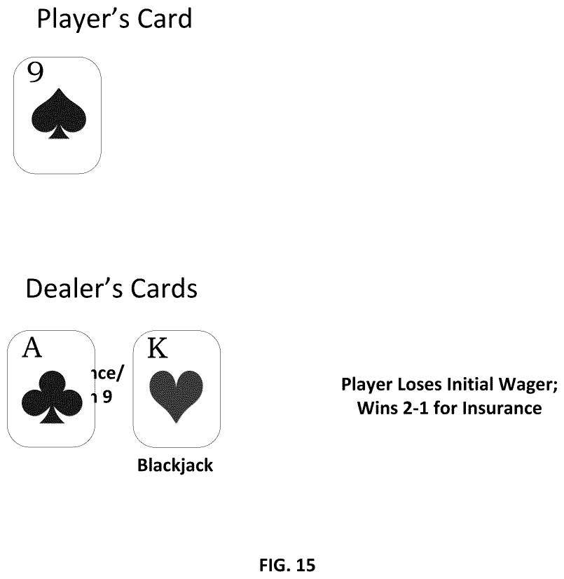

FIG. 15 illustrates that the player loses the initial wager immediately upon the dealer “peeking” at the hole card (FIG. 9A, steps 910-912) when the dealer's first face up card (the second card dealt to the dealer) is an Ace. FIG. 15 also illustrates that the player wins 2-1 on an insurance wager, offered by the dealer at the time the face up Ace was dealt.

In this description, numerous specific details are set forth. However, it is understood that embodiments of the invention may be practiced without these specific details. Although specific ranges, specific compositions, and specific components have been identified to enable preferred practice of the present technology, one skilled in the art, reading the specification and viewing the figures, understands the generic concepts disclosed herein. This understanding enables the use of alternatives and options and design changes within the skill of the ordinary artisan in the electronics and imaging field, without undue experimentation and within the scope of the claims.

For example, while the above exemplar use case includes a bonus wheel displayed on the table sign 660, a mechanical wheel operated by a stepper motor may be connected to the table controller 610 and used in cases where the community prizes and the personal prizes are the same. In some embodiments, a separate video display other than the table sign 660 connected to the table controller 610 may portray the bonus wheels. The use of a wheel is only an example. In other embodiments, any means of determining the community and personal bonus game awards falls within the spirit and scope of the invention.

In a further example, while the above disclosed planar token detection scheme is described as transmitting light above the top surface of the token sensor, other embodiments transmit the light through a top surface “glass” installed over the display and on which the token is placed. With this alternate method, there is no slanted window bezel including focusing lenses mounted above the surface of the display as described above. Rather, one or more light beams are guided within the cover glass itself and the cover glass becomes the waveguide medium between the emitters and detectors. If the cover surface is glass, for example, it has an index of refraction of ˜1.5. The surrounding air has a refraction index of 1. This difference causes total internal reflection for light emitted at approximately 42 degrees from normal. When a token is placed on the surface, this critical angle changes and, thus, the amount of light guided within the cover glass also changes. A determination of token presence or absence can then be based on the amount of light received at the detector.

In accordance with some embodiments, the upper surface of the token sensor is not circular. For example, the planar token detection techniques described above are equally applicable to square or rectangularly shaped upper surfaces of the token sensor. All that is required is that paired emitters and detectors are positioned such that light transmitted by the emitters is blocked their respective detectors when a token is placed on the upper surface of the token sensor. Similarly, while a circular display has been disclosed, a rectangular or square display matching the shape of the upper surface of the token may be particularly suitable. Any combination of upper surface shape and display shape falls within the spirit and scope of the invention.

In the Blackjack example, the first card is described as face down to the dealer, followed by a face up card to each player and a second card, face up, to the dealer. The order of the cards dealt may vary, so long as, when the player(s) make a first decision, the dealer has one face down card, one face up card and each player has a single card which, in some embodiments, may be face down with the player only looking at the card prior to rendering a hit or double down decision.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A plurality of token sensors mountable to an upper surface at respective locations of a gaming table and communicatively coupled to an electronic table controller of the gaming table, each of the plurality of token sensors comprising:
a top surface including a respective electronic display device upon which text or graphics related to a respective potential award of a game is displayed by the respective electronic display device, the respective potential award independently and randomly selected by the electronic table controller for each of the plurality of token sensors;
logic circuitry comprising one or more processors; and
at least one light emitter paired with a light detector, the at least one light emitter positioned to transmit light above the top surface to its paired light detector, the at least one light emitter and its paired light detector positioned such that light transmitted by the at least one light emitter is detectable by its paired light detector;
wherein, via the logic circuitry, each of the plurality of token sensors communicates to the electronic table controller the presence of a token on its respective top surface when the light transmitted by its at least one light emitter is blocked by the token from being detected by its paired light detector.

2. The plurality of token sensors of claim 1, wherein the random selection of each potential award is based on how many tokens are detected by the plurality of sensors.

3. The plurality of token sensors of claim 1, wherein at least one of the potential awards comprises a progressive award.

4. The plurality of token sensors of claim 1, wherein at least one of the potential awards comprises an award modifier.

5. The plurality of token sensors of claim 4, wherein the award modifier comprises a multiplier.

6. The plurality of token sensors of claim 1, wherein the electronic display devices further display attract animations, celebratory animations, or instructions to players of the game played at the gaming table.

7. The plurality of token sensors of claim 1, wherein each token sensor further comprises a gesture sensor for providing input to the electronic table controller.

8. The plurality of token sensors of claim 1, wherein the electronic table controller is communicatively coupled to a remote progressive controller system and wherein the presence of a token on any of the plurality of token sensors provides an input to the progressive controller system.

9. The plurality of token sensors of claim 1, wherein at least one of the displayed potential awards may be won only in response to occurrence of a qualifying hand at the location associated with the displayed potential award.

10. The plurality of token sensors of claim 1, wherein at least one of the displayed potential awards may be won without requiring a qualifying hand at the location associated with the displayed potential award.

11. A method of detecting a token placed on one of a plurality of token sensors mounted to an upper surface of a gaming table, the plurality of token sensors communicatively coupled to an electronic table controller of the gaming table, each of the plurality of token sensors comprising a top surface including a respective electronic display device upon which text or graphics related to a respective potential award of a game is displayed by the respective electronic display device, the respective potential award independently and randomly selected by the electronic table controller for each of the plurality of token sensors, each of the plurality of token sensors further comprising logic circuitry and at least one light emitter paired with a light detector, the logic circuitry comprising one or more processors, the at least one light emitter positioned to transmit light above the top surface of its respective token sensor to its respective light detector, the at least one light emitter and its paired light detector positioned such that light transmitted by the at least one light emitter is detectable by its respective paired light detector, the method comprising:
transmitting light from the at least one light emitter; and
communicating to the electronic table controller, via the logic circuitry, the presence of a token on the top surface when the transmitted light emitter is blocked by the token from being detected by its paired light detector.

12. The method of claim 11, wherein the random selection of each potential award is based on how many tokens are detected by the plurality of sensors.

13. The method of claim 11, wherein at least one of the potential awards comprises a progressive award.

14. The method of claim 11, wherein at least one of the potential awards comprises an award modifier.

15. The method of claim 14, wherein the award modifier comprises a multiplier.

16. The method of claim 11, wherein the electronic display devices further display attract animations, celebratory animations, or instructions to players of the game played at the gaming table.

17. The method of claim 11, wherein each token sensor further comprises a gesture sensor for providing input to the electronic table controller.

18. The method of claim 11, wherein the electronic table controller is communicatively coupled to a remote progressive controller system and wherein the presence of a token on any of the plurality of token sensors provides an input to the progressive controller system.

19. The method of claim 11, wherein at least one of the displayed potential awards may be won only in response to occurrence of a qualifying hand at the location associated with the displayed potential award.

20. The method of claim 11, wherein at least one of the displayed potential awards may be won without requiring a qualifying hand at the location associated with the displayed potential award.
